(19) United States
(12) Patent Application Publication
(10) Pub. No.: US 2021/0072831 A1
(43) Pub. Date: Mar. 11, 2021

(54) SYSTEMS AND METHODS FOR GAZE TO CONFIRM GESTURE COMMANDS IN A VEHICLE

(71) Applicant: Byton North America Corporation, Santa Clara, CA (US)

(72) Inventor: Elizabeth T. Edwards, San Jose, CA (US)

(21) Appl. No.: 16/564,914

(22) Filed: Sep. 9, 2019

(51) Int. Cl. G06F 3/01; G06F 3/0488; G06K 9/00; G02B 27/00

(52) U.S. Cl. CPC G06F 3/017; G06F 3/013; G02B 27/0093; G06K 9/00362; G06K 9/00335; G06F 3/0488

(57) ABSTRACT

Disclosed is a method, system, and apparatus for configuring vehicle systems using gaze confirmed gesture commands. The method may include capturing, with at least one imaging system of a vehicle, image data depicting an occupant of the vehicle. The method may also include detecting a gaze of the occupant to a region of the vehicle depicted within the image data, detecting further comprises determining a user interface context for the region of the vehicle. Furthermore, the method may include detecting a motion command defining an input for configuring a vehicle system depicted within the image data. Additionally, the method may include executing the command to configure the vehicle system when the motion command defines an allowable input for the user interface context.

### FIELD

The disclosed embodiments relate generally to user interfaces and more specifically, but not exclusively, to touchless interaction with a user interface using gaze confirmed gesture commands.

### BACKGROUND

As electronics have proliferated, ways of controlling them and their attributes have improved substantially. Originally, most electronics were controlled using physical controls—knobs, sliders, buttons, etc. Nowadays, many electronics are controlled by software, but in many cases they still require some sort of direct or indirect physical touch by a user; examples include pointing and clicking with a mouse and selecting or manipulating items on a touch screen or touch pad. Disadvantages of these methods of control include that the user must usually pay attention to the device in question, thus distracting attention from other tasks, and that the user must be able to touch a physical control device, which might be difficult if the physical control device is inconveniently placed. This problem is exacerbated in the context of controls in a vehicle, which may divert a user's attention away from operating the vehicle to active or otherwise interact with a vehicle control.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagrams of an embodiment of user interface systems that can be interacted with using gesture command and gaze combinations.

FIG. 2 is a block diagram of an exemplary system architecture for utilizing gesture commands and gaze to control one or more vehicle systems.

FIG. 3 is a diagram of an embodiment of user interaction to execute a command using gesture and gaze.

FIG. 4 is a flow diagram of an embodiment of operation and/or configuration of a vehicle using gaze confirmed gesture commands.

FIG. 5 is a flow diagram of another embodiment of operation and/or configuration of a vehicle using gaze confirmed gesture commands.

### DETAILED DESCRIPTION

Embodiments are described of an apparatus, system and method for touchless interaction with a user interface using gestures or gesture/motion combinations. Specific details are described to provide an understanding of the embodiments, but one skilled in the relevant art will recognize that the invention can be practiced without one or more of the described details or with other methods, components, materials, etc. In some instances, well-known structures, materials, or operations are not shown or described in detail but are nonetheless within the scope of the invention.

Reference throughout this specification to “one embodiment” or “an embodiment” means that a described feature, structure, or characteristic can be included in at least one described embodiment, so that appearances of “in one embodiment” or “in an embodiment” do not necessarily all refer to the same embodiment. Furthermore, the described features, structures, or characteristics may be combined in any suitable manner in one or more embodiments.

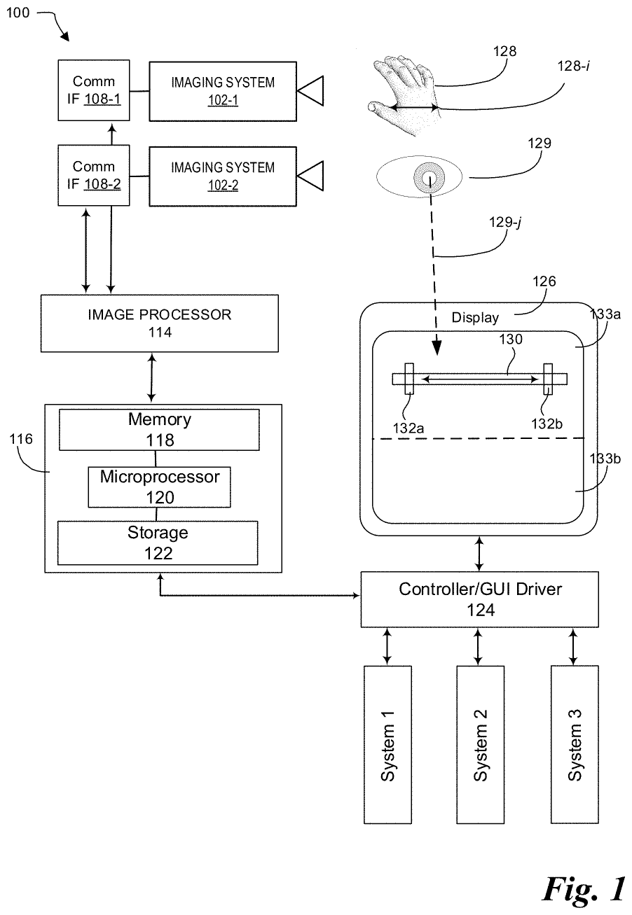

FIG. 1 illustrates an embodiment of a user interface system 100 in which gaze and gestures of one or more human body parts allow a user to interact with the user interface and, through the user interface, to control one or more underlying systems. In embodiments, and as discussed in greater detail herein, the underlying systems may be systems of a vehicle, such as vehicle control systems, navigation systems, entertainment systems, etc. In the illustrated embodiments, the human body part is a human hand, but in other embodiments gestures may be initiated by other body parts, such as the head, arm, face, etc. Still other embodiments can use gestures with multiple body parts.

In embodiments, as discussed in greater detail herein, gestures are used in combination with gaze detection in order to prevent false positives for gesture commands (e.g., configuring and/or controlling a vehicle system in response to a user movement that is unintentionally interpreted as a gesture command). For example, a user may move their hand in such a way that it is consistent with a command to turn an audio system's volume up, even though they do not intend to issue such a command. This creates an annoying, and potentially unwanted change, to a vehicle system. Furthermore, gestures are used in combination with gaze detection to additionally distinguish between how gesture commands are interpreted and executed. For example, the same gesture command may provide a different form of input and/or vehicle system configuration based on a context in which the command is issued. In embodiments, the context is the interface or underlying system that is to be configured by the gesture command, and which may be confirmed using gaze detection as discussed below.

System 100 includes camera systems 102-1 and 102-2 communicatively coupled to an image processor 114 via communications interfaces 108-1 and 108-2. Image processor 114 is in turn communicatively coupled to a computer 116, and computer 116 is further communicatively coupled to a controller/graphic user interface (GUI) driver 124. Controller/GUI driver 124 is then further communicatively coupled to a display 126, one or more underlying systems 1-3, and in some embodiments to one or more additional displays (not shown).

Camera system(s) 102-1 and 102-2 may be time of flight based camera systems (e.g., a VCSEL laser technology based camera system that create three-dimensional image, video, or other image data of an object, such as human hand 128 or eye 129) that operate in one or more light spectrums (e.g., infrared, RGB, etc.). In embodiments, imaging system 102-1 and 102-2 are the same type (e.g., both time of flight based camera systems) or different type of imaging system (e.g., imaging system 102-1 may be a RGB depth camera system or an infrared time of flight camera operating in a first spectrum range, such as for example in the 850 nm near infrared range, whereas imaging system 102-2 may be an RGB camera system or IR monochrome camera system having infrared illuminators on sides of the IR operating a second spectrum range, such as for example in the 940 nm infrared range). In embodiments, both imaging systems may operate in the infrared or near infrared ranges, such as those mentioned above or within similar ranges, but operate at different wavelengths so as not to interfere with one another. Furthermore, operating in the above exemplary infrared ranges enables camera systems 102-1 and 102-1 to operate and perform gesture and gaze detection in low and/or challenging ambient lighting conditions, such as nighttime lighting conditions, which are typically experienced during vehicle operation. In embodiments, camera systems are selected and used based on whether the camera system is to capture hand 128 or eye 129. In one embodiment, each of camera systems 102-1 and 102-2 are in turn coupled to a communication interface 108-1 or 108-2, through which camera systems 102-1 and 102-2 can transmit captured video and/or still images to image processor 114.

Image processor 114 and computer 116 together process images received from camera systems 102-1 and 102-2 to detect gestures of user's hand 128 as well as gaze direction and gaze target of user's eye 129. In the illustrated embodiment, image processor 114 and computer 116 are shown as separate components, but in other embodiments image processor 114 and computer 116 can be embodied in the same component. For example, in another embodiment image processor 114 and computer 116 can be different processes running on a single computer—that is, running on a single piece of hardware. Furthermore, in embodiments, each imaging system (e.g., system 102-1 and 102-2) may be coupled with their own image processor, which for example, is an image processor that performs operations specific to the type of detection (e.g., gesture or gaze) being performed.

In the illustrated embodiment, image processor 114, having received images or video from camera systems 102-1, can process the images or video to produce a digital representation of user's hand 128. For instance, software running on image processor 114 can identify certain strategic portions of the hand, such as knuckles or other joints in one embodiment, and create a digital representation of the hand 128 based on the locations of these strategic portions in the video and/or image data. Having created a digital representation of the hand 128, image processor 114 can then, based on the digital representation, detect motions and/or gestures 128-i made by hand 128. In embodiments, the detected gesture 128-i is one of a plurality of gestures that can be issued by hand 128. Alternatively, gesture detection can be performed by computer 116 or can be performed partially by image processor 114 and partially by computer 116. Suitable commercially available software that can create the digital representation and identify the gesture includes the SoftKinetic software created by Sony Corp. of Tokyo, Japan.

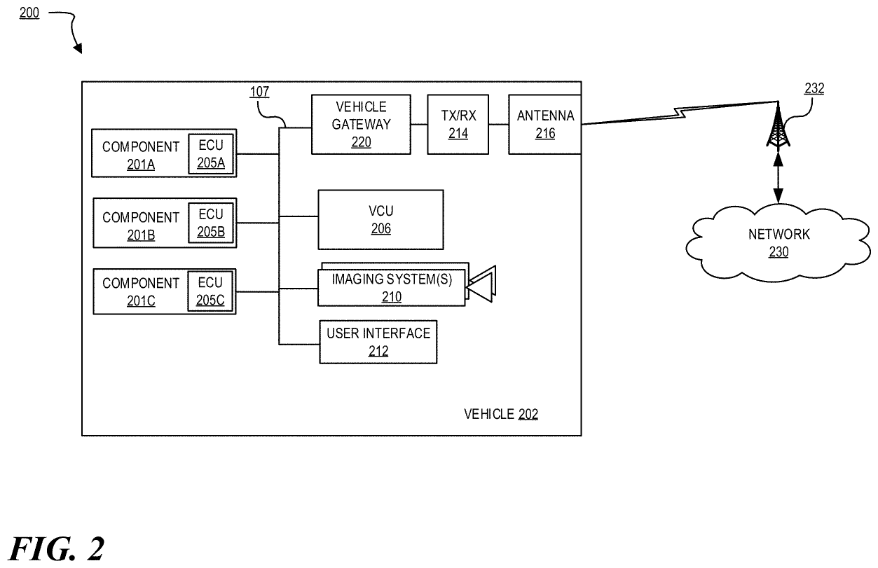

Similarly, in the illustrated embodiment, image processor 114, having received images or video from camera systems 102-2, can process the images or video to produce gaze detection and gaze target on the user's eye 129. In embodiments, gaze detection includes processes for measuring and monitoring a point of gaze of a user to regions of a vehicle in which system 100 is used, for example vehicle 202 in FIG. 2. For example, a gaze may be detected by detecting and monitoring anatomical features of user's eye 129 in the image data to determine various regions of a vehicle a user is currently looking at, such as a user looking at a graphical user interface (e.g., display 126), a region of a graphical user interface (e.g., region 133a or 133b of the display 126), other regions (not shown) such as windows, mirrors, steering wheel, seat, or other systems of a vehicle) based on measuring anatomical features of the eye. In embodiments, any suitable software and/or hardware that can capture image data and identify gaze and determine a target of the gaze may be used by image processing 114 and/or computer 116, such as glint detection and location based techniques using software and/or hardware packages/systems developed by Veoneer or Seeing Machines, for performing gaze detection.

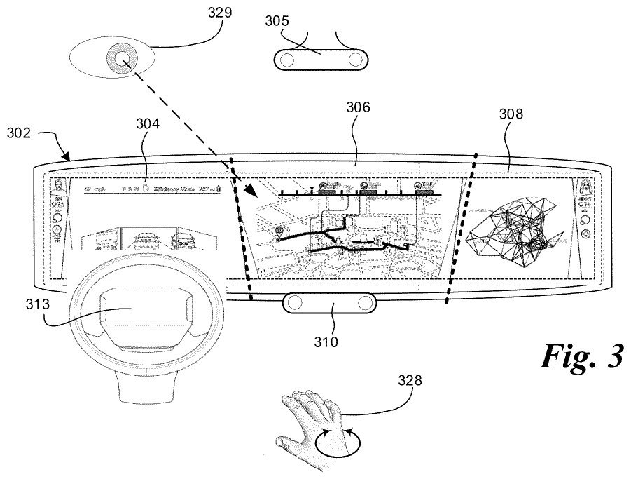

Computer 116 is communicatively coupled to image processor 114 and includes a microprocessor 120 which is communicatively coupled to both a memory 118 and storage 122. In one embodiment, computer 116 can receive image data from image processor 114, and then analyze detected gestures and gazes. In embodiments, gesture and gaze detection for configuration of a vehicle may be predicated on user authorization, such verification of gesture and/or gaze detection preferences, permissions, etc. associated with a current operator of the systems/vehicle. In embodiments, where system 100 is used in a vehicle, memory 118 stores a definition of regions of the vehicle, such as regions defining a user interface (see, e.g., FIG. 3 where user interface 302 has regions 304, 306, and 308 corresponding to real world locations where vehicle controls, navigation, and entertainment user interfaces are displayed). In embodiments, the regions may be defined for various user interface regions (e.g., specific user interface regions, a grid of regions dividing a user interface, regions defining specific controls within a user interface, etc.), zones of the automobile (e.g., front, rear view, size view, etc.), areas of interest (e.g., a region associated with a specific vehicle system, such as a steering wheel, seat, etc.). Any number of regions and corresponding real world location can be defined for a vehicle. In embodiments, each of the defined regions is assigned a gaze identifier in memory 118 that can be referenced when image processing 114 detects a user's gaze to a corresponding region.

Furthermore, memory 118 further stores, for each type of gesture which can be detected, a gesture ID. For example, image processor 114 may recognize various gestures, such as hand up, hand down, a clockwise circular motion, counterclockwise circular motion, zig zag motion, push, pull, hand close, etc. In embodiments, each gesture may be given a gesture ID. The various user interface input contexts can be given command functionality for the various gestures based on gesture ID and a determined relationship to a given context. For example, a gesture ID for a detected circular motion may be associated with different command inputs based on the context in which it is detected. As discussed herein, a user interface context refers to the system, current graphical user interface, etc. to which a user is looking at or has looked at when performing a gesture command. For example, user interface rendered on display 302 in FIG. 3 has three regions 304, 306, and 308. Furthermore, each region has a specific user interface context, for example, the user interface context of region 304 may be a vehicle operation context, the user interface context of region 306 may be a vehicle navigation context, and the user interface context of region 308 may be a media control context. Various user interfaces, zones, regions, etc. may be associate wither their own unique contexts consistent with the discussion herein. Then, depending on which context a gesture command having an associated gesture ID is directed at, the same command may be interpreted to provide different functionality (e.g., a swipe motion in a navigation context may cause a map display to move, whereas a swipe motion in a media control context may skip a song being played on a media system).

Having identified the gestures and gazes, and thus corresponding gesture IDs and gaze IDs, computer 116 can then try to associate the incidence of a specific gesture ID to a specific gaze ID to generate and execute a user command to configure a vehicle. This can be done, in an embodiment, by comparing a time when the gesture ID and gaze ID are detected to determine if they occur within a threshold time of one another. In another embodiment, gaze may first be detected at a region to wake up or activate gesture command recognition, so that detection of a gesture within a threshold amount of time is considered to be associated with the gaze detection. For example, simultaneous or temporally close gestures and gazes may be user by computer 116 to infer that a user intended a gesture to be associated with the gaze. Then, the gaze ID can be used to determine the region a user is or was looking at for command input associated with a gesture ID detection. Then, based on a context associated with the region, computer 116 can determine whether the command input from the gesture associated with the gesture ID defines a valid input given the context. In embodiments, a valid input is one that is defined for a context (e.g., a volume up down gesture is allowed in the context of a media region, wherein the same gesture may not be defined for a vehicle operation gesture). In embodiments, computer 116 uses the defined regions, determination of gesture IDs relationships to contexts, and temporally detected instances of gestures and gazes to determine if a user has issued a valid input command. In embodiments, input commands are based on the incidence of both a gaze (e.g., to a region within vehicle having a context) and gesture (e.g., providing a valid input given the context) to issue commands. By determining the occurrence of a gesture and gaze, their temporal relationship within a threshold time, and a context in which a detected gesture ID and gaze ID are detected, user intent for specific commands is greatly improved, as well as avoiding false positive gesture detection. Additional techniques for confirming user intent (e.g., increasing confidence of execution of correct command), such as voice commands based on gaze and/or gesture, using a visual or audio output to indicate a gaze confirmed gesture command and executing the command based on use confirmation (e.g., speaking “execute”, performing a secondary gesture, etc.), may be used consistent with the techniques discussed herein. The user input commands, as detected by computer 116 based on gesture and gaze, are then provided to controller/GUI driver 124.

Controller/GUI driver 124 is communicatively coupled to computer 116 to receive user commands that computer 116 has determined correspond to the gesture and gaze combination made by hand 128 and eye 129. Although in the illustrated embodiment it is shown as a separate component, in other embodiments the functions of controller/GUI driver 124 can be incorporated into and performed by computer 116. Controller/GUI driver 124 is also coupled to display 126, which can display a set of one or more graphic user interface controls that can then be selected, manipulated, or otherwise interacted with based on the user commands received from computer 116 (e.g., the combination of gestures with gazes). Furthermore, controller/GUI driver 124 may react to gaze detection by altering a user interface (e.g., shadowing, highlighting, adjusting color, etc.) in response to gaze detection in order for a vehicle occupant to visually identify what region their gaze is detected in. In some embodiments controller/GUI driver 124 can also be coupled to one or more additional displays (not shown). In an embodiment with additional displays, different displays can show the same or different user interface control sets and gestures/gazes combinations can be used to control the other displays, for example by vehicle passengers.

The graphic user interface controls shown on display 126 can be context dependent; that is, the particular set of user interface controls shown on display 126 can depend on the system for which they are being used, or the function for which they are being used within a particular system. In the illustrated embodiment, the graphic user interface control is a slider 130 over which a handle can be moved from position 132a to position 132b, by the correct gesture and gaze to alter some attribute of an underlying system. Any type of graphical control can be used to operate, configure, etc. systems of a vehicle, the display 126, etc.

Underlying systems 1-3 are also coupled to controller/GUI driver 124. Although only three systems are shown in the illustrated embodiment, other embodiments can have more or less systems than shown. Systems 1-3 are the systems whose attributes are being controlled by the interaction of the commands resulting from gesture and gaze detection, via the user interface controls displayed by controller/GUI driver 124 on display 126, as well as other systems for which a region has been defined. For instance, in an automobile embodiment, system 1 could be a sound system whose volume is being adjusted with gaze and gesture combinations, system 2 could be a vehicle operation system (e.g., an automated driving system) whose mode of operation is being adjusted with gaze and gesture combinations, and system 3 could be a navigation system whose routing is being adjusted by gaze and gesture combinations. In an automobile embodiment, systems 1-3 can include any number and combination of typical vehicle systems that can be configured by an operator of the vehicle, including a sound, a navigation, a telephone, suspension, air-conditioning, interior lighting, exterior lighting, locking, battery management, power management, and other systems.

FIG. 2 is a block diagram of an exemplary system architecture 200 for utilizing the incidence of gesture and gaze to control one or more vehicle systems. In embodiments, vehicle 202 may be a fully electric vehicle, partially electric (i.e., hybrid) vehicle, non-electric vehicle (i.e., a vehicle with a traditional internal combustion engine). Furthermore, although described mostly in the context of automobiles, the illustrated systems and methods can also be used in other wheeled vehicles such as trucks, motorcycles, buses, trains, scooters, etc. It can also be used in non-wheeled vehicles such as ships, airplanes (powered or gliders), and rockets.

System 200 includes vehicle 202 communicatively coupled to network 130. In the context of this application, “communicatively coupled” means coupled in such a way that data can be exchanged, in one or both directions, between two entities or components (e.g., between the vehicle 202 and another system (not shown) via network 230).

In one embodiment, vehicle 202 includes one or more systems, such as components 201, which may each have an electronic control unit (ECU) 205, and each ECU 205 is communicatively coupled via a communications network 207 to a vehicle control unit (VCU) 206. VCU 206 may be a central computer system (e.g., computer 116) of vehicle 202. The communications network 207 may be a controller area network (CAN), an Ethernet network, a wireless communications network, another type of communications network, or a combination of different communication networks. VCU 206 is also communicatively coupled to other vehicle systems, such as imaging system(s) 210, a user interface 212, and a transceiver 214. Transceiver 214 is communicatively coupled to an antenna 216, through which motor vehicle 202 can wirelessly transmit data to, and receive data from, other systems (e.g., other vehicle, third party computing systems., etc.). In the illustrated embodiment, vehicle 202 communicates wirelessly via antenna 216 with a tower 232, which can then communicate via network 230 (e.g., a cellular communication network, a local area network, a wide area network, a combination of networks, etc.) with other systems. In embodiments, vehicle 202 may also form other wireless connections, such as vehicle-to-vehicle connections, local area network connection, personal area network connections, using antenna 216 as well as other communications subsystems of the vehicle.

Components 201 are generally components of the systems of the vehicle 202. For example, components 201 can include adjustable seat actuators, power inverters, window controls, electronic braking systems, trunk and door controls, automatic ignition systems, convenience systems such as heating and/or air conditions systems, audiovisual systems, ADAS systems, automated driving systems, etc. Vehicle control unit (VCU) 206 is another vehicle 202 system that serves as a controller including a microprocessor, memory, storage, and a communication interface with which it can communicate with components 201, imaging system(s) 210, user interface 212, and transceiver 214 via network 207. In one embodiment VCU 206 is the vehicle's main computer (e.g., computer 116), but in other embodiments it can be a component separate from the vehicle's main or primary computer.

Imaging system(s) 210 capture image data (still or video) depicting gaze and gestures by an occupant of the vehicle within the captured image data. As discussed herein, the capture and/usage of such image data may require the receipt and verification of a user account and/or preferences. The occupant may be the vehicle operator (e.g. driver), and in some embodiments can also include passenger(s), where passenger gaze and gesture command acceptance may also be confirmed in vehicle operator preferences. In embodiments, VCU 206 receives the captured image data and performs various image processing operations, such as gesture recognition operations, gaze detection operations, gaze location extrapolation, etc. using the techniques discussed herein. As discussed herein, the image processing is performed to detecting certain gestures, associated with gesture IDs, and determinations where user gazes are directed to, associated with gaze ID. Then, when the gesture ID is determined simultaneously with or within a threshold time of the gaze IDs, VCU 206 can use the current state of the vehicle to determine a user interface context associated with the gaze ID (e.g., for a region associated with the gaze ID, what is the current display rendered on user interface 212, what is the vehicle system to which a gaze is directed, etc.). Based on the user interface context, if the gesture ID defines an allowable input for the context, VCU 206 issues the command from the gesture ID for the context to the appropriate vehicle system(s). In embodiments, the gesture command, when matched with the appropriate gaze, may be used by an occupant of the vehicle to configure, alter, adjust, or otherwise control various vehicle systems without direct physical interaction with those systems. For example, the gaze and gesture combinations can be used to adjust driver operation settings (e.g., drive mode characteristics including accelerator, braking, and traction control systems), media control settings (e.g., volume, media source, display screen, etc.), vehicle characteristics (e.g., windows opened/closed), as well as any other system that a user may configured.

In embodiments, it is the fusion of the gaze and gesture sensor data that enables the VCU to perform gazed confirmed gesture commands. The touchless control enables a user to minimize distraction during driving by eliminating the need to physically interact with various vehicle systems. Furthermore, by using the combination of gaze (e.g., user view location and context determination) with motion command (e.g., user specified touchless input for a given context), user intent is better reflected in the executed gesture commands. Additionally, inadvertent gesture commands (e.g. false positives) are avoided when random or uninitiated user movements may be confused with otherwise legitimate motion commands. Additionally, other forms of input and/or confirmation, such as voice commands, may be used to add additional accuracy for command selection and execution.

FIG. 3 is a diagram of an embodiment of user interaction to execute a command using gesture and gaze. FIG. 3 illustrates an automobile dashboard 302, which includes a plurality of displays rendered in a graphical user interface. In the illustrated embodiment dashboard 302 includes a single display which can be configured to display different things in three software-configurable graphical user interfaces. In one embodiment, the graphical user interfaces correspond with defined regions 304, 306, and 308 of a vehicle (e.g., a mapping of real world locations of the display regions with gaze IDs, such as a unique gaze ID being associated with each of regions 304-308). In still other embodiments, regions 304, 306, and 308 and their associated gaze IDs can be associated with physically separate displays. Additionally, as discussed herein, any number of regions and associated gaze IDs can be defined for the display rendered in dashboard (e.g., regions may define a grid, rows, columns, specific areas, etc. of varying levels of granularity and/or size), other areas of interest (e.g., regions defined outside of the dashboard), other zones, etc. In the illustrated embodiment, region 304 can be associated with a context for driving controls, region 306 can be associated with a context for an interactive mapping/navigation, and region 308 can be associated with a region for media and entertainment control, with which a vehicle operator/driver (and in some embodiments for some regions passenger(s)) can interact with gaze confirmed gestures.

Dashboard 302 can also include an imaging system 310 for capturing image data used for gaze detection and gaze location tracking, as discussed herein. In an embodiment, imaging system 310 may be an imaging system for performing driver monitoring, such as gaze recognition, and utilizes a single monochrome camera with two infrared illuminators, such as LED illuminators, on the left and right side of the camera in order to detect the glint off of the eye for glint based gaze detection techniques. In embodiments, imaging system 310 operates in the 940 nm infrared range. Imaging system 310, is positioned below regions 304, 306, and 308 to capture video or images of at least one of the driver's eyes. In embodiments, imaging system 310 may also be located within a vehicle independent of the dashboard 302. For example, in some embodiments, imaging system 310 may be positioned with imaging system 305, left and right of the display, as well as other regions in which the imaging system 310 could capture image data depicting driver gaze. In embodiments, where a passenger (front or rear) are to be allowed to issue gaze confirmed gesture commands, camera system 310 or other camera systems (not shown) may be used to capture image and/or video data depicting passenger gazes. In embodiments, a display 313 can be positioned in the center of the steering wheel to act as a user input device and to provide additional display capabilities for the driver, and may also be controlled using gaze confirmed gesture command as discussed herein.

Imaging system 305 can also be positioned in the cabin, for instance where a rear-view mirror, overhead console, etc. is or, if not present, where it normally would be, to capture video or still images of a driver and front passenger's arms and hands. In embodiments, imaging system 305 can be used for gesture detection of at least one of the driver's hands. In an embodiment, imaging system 305 is a depth camera system for capturing image data depicting driver and/or passenger gestures, for example using a time of flight based imaging system, such as an imaging system operating in the 850 nm near infrared range and having its own VCSEL illuminator(s). Similar to the discussion above, additional imaging systems or imaging system 305 may also be used to capture gestures made by vehicle passengers, in embodiments. Furthermore, in embodiments, imaging system 305 is located above and pointing down at a vehicle operator with a slight pitch (e.g., 2 degrees toward the display) to improve gesture detection accuracy.

In embodiments, a computing system of a vehicle, such as computer 116 or VCU 206, may use the image data captured by imaging systems 305 and 310 for analysis of image data depicting gestures of a user's hand 328, gaze direction and location of a user's eye 329, and to perform gaze confirmed gesture command execution, as discussed herein. Furthermore, in embodiments, separate processing systems unit may be used to perform gaze detection, gesture detection, and fusing of determined gaze IDs with gesture IDs for determining appropriate gaze confirmed gesture command execution, as discussed herein.

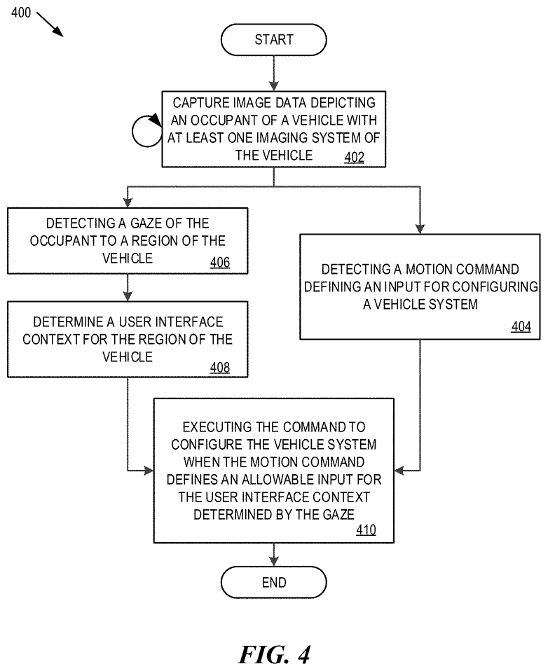

FIG. 4 is a flow diagram 400 of an embodiment of operation and/or configuration of a vehicle using gaze confirmed gesture commands. The method 400 is performed by processing logic that may comprise hardware (circuitry, dedicated logic, etc.), software (such as is run on a general purpose computer system or a dedicated machine), firmware, or a combination. In one embodiment, the method 300 is performed by a user interface system or vehicle (e.g., user interface system 100 or vehicle 202).

Referring to FIG. 4, processing logic begins by capturing image data depicting an occupant of a vehicle with at least one imaging system of the vehicle (processing block 402). In embodiments, the image data is still or video image data, captured periodically or in real time during use and/or operation of the vehicle. In embodiments, there are two imaging systems, and one of which captures depth image data while the other captures time of flight based three dimensional data, including a first imaging system capturing depth data/3D data and located above and angled down at the occupant (e.g. deployed in or near a rear view mirror of the vehicle), and a second imaging system capturing 2D or 3D image data and located lower (e.g. hand or body level in a dashboard or console of the vehicle). In embodiments, the imaging systems provide image data to processing logic for different purposes (e.g. the first imaging system captures image data for gesture recognition) determination, and the second imaging system captures image data for gaze detection and gaze location via pupil detection and eye glint information. However, in other embodiments, the imaging systems may each be used to perform either or both of gaze and gesture recognition, and/or may perform alternative recognition processes.

Processing logic utilizes the captured image data to detect a gaze of the occupant to a region of the vehicle (processing block 406) and determine a user interface context for the region of the vehicle (processing block 408). As discussed herein, any of a number of suitable gaze detection and gaze location techniques may be used by processing logic, such as glint based gaze detection. Furthermore, based on a detected gaze direction, location of the gaze (e.g. to what a user is looking at) within the vehicle can be determined. In embodiments, the detected gaze location is a point projected onto the user interface as a result of the gaze detection. In embodiments, the gaze need not remain on a region to be detected by processing logic, and may be a glance or other temporary look at a region, for which a projection point is determined. Furthermore, in embodiments, a glance duration may be used by processing logic for gaze detection based on a speed of the vehicle (e.g., faster speed associated with shorter glance duration), a current mode of operation (e.g., driving has shorter glance duration than when vehicle is in park), whether autonomous driving is being used, etc. for gaze detection. What the occupant gazed at is associated with a context, for example regions defined for a user interface and the user interface currently being displayed, vehicle zones, areas or interest, or other divisions of the vehicle. In embodiments, gaze detection and context recognition may be used by processing logic to inform the vehicle operator as to which region the operator gaze is detected to, for example, by updating a user interface to the region (shadowing, highlighting, or otherwise visually distinguishing the user interface region to which a gaze is detected), playing a visual chime, etc. Furthermore, in embodiments, detection of gaze and context may instruct/inform processing logic to perform processing block 408, set timer in which processing block is to be performed, start an initial time by which a threshold time for gesture recognition is judged, etc.

Processing logic further utilizes the captured image data to detect a motion command defining an input for configuring a vehicle system (processing block 404). In embodiment, processing logic extracts features from the image data depicting user motions, for example by a hand, face, arm, etc., and based on the motion of the extracted features depicted in the image data, detects a motion command. For example, processing logic may implement processes such as those of the SoftKinetic software to capture and recognize gestures of the occupant within the vehicle.

In embodiments, gaze detection and gesture recognition may be performed in parallel or in sequence.

Processing logic then executes the command to configure the vehicle system when the motion command defines an allowable input for the user interface context determined by the gaze (processing block 410). That is, for example, the command is executed by processing logic when the command is allowed for the given context (e.g. location, current user interface, zone, region, etc. that a user is looking at). In other words, a motion command that is only defined for a media system will not execute a command to configure a navigation system, even though the command is valid in some contexts. Rather, processing logic ensure that before a command is executed, there is an incidence of both a motion command and a gaze to a configurable vehicle system (e.g. a context), for which the motion command is associated. By ensuring the proper context associated with the gaze, and a motion command defined for that context, a gaze confirmed motion command can be executed by processing logic.

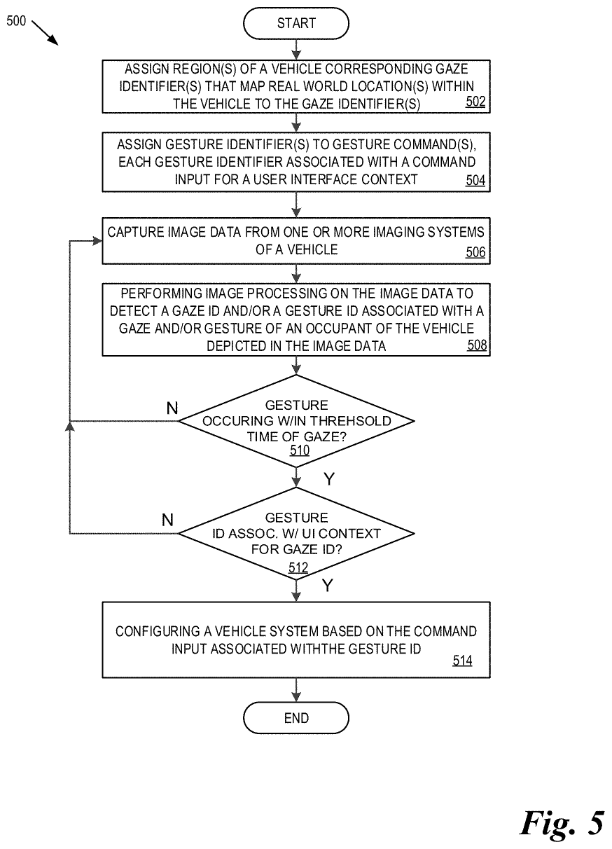

FIG. 5 is a flow diagram 500 of another embodiment of operation and/or configuration of a vehicle using gaze confirmed gesture commands. The method 500 is performed by processing logic that may comprise hardware (circuitry, dedicated logic, etc.), software (such as is run on a general purpose computer system or a dedicated machine), firmware, or a combination. In one embodiment, the method 500 is performed by a user interface system or vehicle (e.g., user interface system 100 or vehicle 202).

Referring to FIG. 5, processing logic begins by assigning region(s) of a vehicle corresponding gaze IDs that map real world locations within the vehicle to the gaze IDs (processing block 502). In embodiments, any number of regions may be defined within a vehicle, and unique gaze IDs associated with those regions. In embodiments, each gaze ID is associated with a single region, and thus a gaze detected by a vehicle occupant at the region may be associated with the corresponding gaze ID.

Processing logic further assigns gesture IDs to gesture commands, where each gesture ID is associated with a command input for a user interface context (processing block 504). In embodiments, gesture commands define inputs used for configuring vehicle systems. Furthermore, the same gesture may perform different inputs based on the context in which it is intended to be used. Thus, in embodiments, unique gesture IDs differentiate between different gesture as well as the same gesture used in different context. Furthermore, the context is the same context that is used to define gaze IDs. As a result, for a given gaze ID and gesture ID, it is efficient for processing logic to determine if the gesture is being used in an allowable context (e.g., processing block 512).

Processing logic captures image data from one or more imaging system of the vehicle (processing block 506), and performs image processing on the image data to detect a gaze ID and/or gesture ID associated with a corresponding gaze and/or gesture of an occupant of the vehicle as depicted in the image data (processing block 508). In embodiments, the gesture ID is associated with one of a plurality of potential gesture IDs associated with corresponding recognizable gestures, and the gaze ID is associated with a projected point onto a user interface and the context to which the projected point belongs (e.g., what the user interface is currently rendering and what the gaze is directed to).

When the gesture does not occur within a threshold time of the gaze (processing block 510), processing logic returns to processing block 506 to continue to capture image data. In embodiments, the determination of whether gesture and gaze occur in a temporally related way ensures that proper user intent is determined (e.g., a user intended a motion based gesture command to be applied to a given context). Thus, when the gesture occurs within the threshold time of the gaze (processing block 510), processing logic then determines whether the gesture ID associated with the user interface context for the gaze ID match (processing block 512). That is, processing logic ensures that the gesture command is relevant to the configurable vehicle system the user is currently (or recently) looking at. When the IDs do not match (e.g., the gesture command is not associated with the gaze's context), processing logic again returns to processing block 506. However, when there is a match, processing logic configures a vehicle system (e.g., updates vehicle settings, adjusts vehicle outputs, configures driver assistance systems, updates user interfaces, etc.) based on the command input associated with the gesture ID (processing block 514).

Those of skill would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), a system on a chip (SOC) an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the methods, systems, and apparatus of the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for configuring vehicle systems using gaze confirmed gesture commands, the method comprising:
capturing, with at least one imaging system of a vehicle, image data depicting an occupant of the vehicle;
detecting, by a processing system of the vehicle, a gaze of the occupant to a region of the vehicle depicted within the image data, wherein the detecting further comprises determining a user interface context for the region of the vehicle;
detecting, by the processing system of the vehicle, a motion command defining an input for configuring a vehicle system depicted within the image data; and
executing, by the processing system, the command to configure the vehicle system when the motion command defines an allowable input for the user interface context.

2. The method of claim 1, further comprising:
determining a gaze identifier from among a plurality of gaze identifiers associated with the detected gaze based on the user interface context for the region of the vehicle to which the occupant of vehicle is directing their gaze;
determining a gesture identifier from among a plurality of gesture identifiers associated with the motion command based on one or more motion signatures detected within a motion of a hand of the occupant of the vehicle; and
determining when the gaze identifier is related to the gesture identifier; and
in response to determination that the gaze identifier is related to the gesture identifier, executing the command.

3. The method of claim 2, wherein determining when the gaze identifier is related to the gesture identifier further comprises:
determining that the gaze identifier is related to the gesture identifier when the detected gaze and the detected motion command occur at least in part at the same time.

4. The method of claim 2, wherein determining when the gaze identifier is related to the gesture identifier further comprises:
determining that the gaze identifier is related to the gesture identifier when the detected gaze and the detected motion command occur within a threshold amount of time of each other.

5. The method of claim 4, wherein the detected gaze occurs before the detected motion command.

6. The method of claim 1, wherein the region is one of a plurality of regions of a graphical user interface, wherein each region defines an input context for a gaze confirmed gesture command, and wherein each input context is associated with a current display rendered within the graphical user interface within the corresponding region.

7. The method of claim 6, wherein the plurality of regions comprises at least a navigation graphical user interface region and a media control graphical user interface region.

8. The method of claim 1, wherein the at least one imaging system comprises a first imaging system capturing first image data depicting one or more eyes of the occupant of the vehicle and a second imaging system capturing second image data depicting one or more hands of the occupant of the vehicle.

9. The method of claim 8, wherein the first imaging system comprises a monochrome image sensor with infrared illuminators on a left and right side of the monochrome image sensor operating in a first light spectrum range, and wherein the second imaging system comprises a time of flight vertical-cavity surface emitting laser depth imaging system operating in a second light spectrum range, wherein the first light spectrum range is an infrared light spectrum range and the second light spectrum range is a near infrared light spectrum range different from the first light spectrum range.

10. The method of claim 9, wherein the first imaging system is disposed below a display rendering a graphical user interface to the occupant, and wherein the second imaging system is disposed within a vehicle console or rear view mirror located above the occupant within the vehicle, and imaging sensors of the second imaging system are directed down at the occupant with a pitch towards the display.

11. A system for configuring vehicle systems using gaze confirmed gesture commands, comprising:
a memory;
at least one imaging system to capture image data depicting an occupant of the vehicle; and
one or more processing systems communicably coupled with the memory and the imaging systems, the one or more processing systems configured to:
detect a gaze of the occupant to a region of the vehicle depicted within the image data, wherein the detecting further comprises determining a user interface context for the region of the vehicle,
detect a motion command defining an input for configuring a vehicle system depicted within the image data, and
executing the command to configure the vehicle system when the motion command defines an allowable input for the user interface context.

12. The system of claim 11, further comprising the one or more processing systems further configured to:
determine a gaze identifier from among a plurality of gaze identifiers associated with the detected gaze based on the user interface context for the region of the vehicle to which the occupant of vehicle is directing their gaze;
determine a gesture identifier from among a plurality of gesture identifiers associated with the motion command based on one or more motion signatures detected within a motion of a hand of the occupant of the vehicle; and
determine when the gaze identifier is related to the gesture identifier; and
in response to determination that the gaze identifier is related to the gesture identifier, execute the command.

13. The system of claim 12, wherein the one or more processing systems configured to determine when the gaze identifier is related to the gesture identifier further comprises the one or more processing systems configured to:
determine that the gaze identifier is related to the gesture identifier when the detected gaze and the detected motion command occur at least in part at the same time.

14. The system of claim 12, wherein the one or more processing systems configured to determine when the gaze identifier is related to the gesture identifier further comprises the one or more processing systems configured to:
determine that the gaze identifier is related to the gesture identifier when the detected gaze and the detected motion command occur within a threshold amount of time of each other.

15. The system of claim 11, wherein the region is one of a plurality of regions of a graphical user interface, wherein each region defines an input context for a gaze confirmed gesture command, and wherein each input context is associated with a current display rendered within the graphical user interface within the corresponding region.

16. The system of claim 11, wherein the at least one imaging system comprises a first imaging system capturing first image data depicting one or more eyes of the occupant of the vehicle and a second imaging system capturing second image data depicting one or more hands of the occupant of the vehicle.

17. The system of claim 16, wherein the first imaging system comprises a monochrome image sensor with infrared illuminators on a left and right side of the monochrome image sensor operating in a first light spectrum range, and wherein the second imaging system comprises a time of flight vertical-cavity surface emitting laser depth imaging system operating in a second light spectrum range, wherein the first light spectrum range is an infrared light spectrum range and the second light spectrum range is a near infrared light spectrum range different from the first light spectrum range.

18. The system of claim 17, wherein the first imaging system is disposed below a display rendering a graphical user interface to the occupant, and wherein the second imaging system is disposed within a vehicle console or rear view mirror located above the occupant within the vehicle, and imaging sensors of the second imaging system are directed down at the occupant with a pitch towards the display.

19. A non-transitory computer readable storage medium including instructions that, when executed by a processor, cause the processor to perform operations for configuring vehicle systems using gaze confirmed gesture commands, the operations comprising:
capturing, with at least one imaging system of a vehicle, image data depicting an occupant of the vehicle;
detecting, by a processing system of the vehicle, a gaze of the occupant to a region of the vehicle depicted within the image data, wherein the detecting further comprises determining a user interface context for the region of the vehicle;
detecting, by the processing system of the vehicle, a motion command defining an input for configuring a vehicle system depicted within the image data; and
executing, by the processing system, the command to configure the vehicle system when the motion command defines an allowable input for the user interface context.

20. The non-transitory computer readable storage medium of claim 19, further comprising:
determining a gaze identifier from among a plurality of gaze identifiers associated with the detected gaze based on the user interface context for the region of the vehicle to which the occupant of vehicle is directing their gaze;
determining a gesture identifier from among a plurality of gesture identifiers associated with the motion command based on one or more motion signatures detected within a motion of a hand of the occupant of the vehicle; and
determining when the gaze identifier is related to the gesture identifier; and
in response to determination that the gaze identifier is related to the gesture identifier, executing the command.

21. The non-transitory computer readable storage medium of claim 19, wherein the region is one of a plurality of regions of a graphical user interface, wherein each region defines an input context for a gaze confirmed gesture command, and wherein each input context is associated with a current display rendered within the graphical user interface within the corresponding region.

22. The non-transitory computer readable storage medium of claim 19, wherein the at least one imaging system comprises a first imaging system capturing first image data depicting one or more eyes of the occupant of the vehicle and a second imaging system capturing second image data depicting one or more hands of the occupant of the vehicle.

23. The non-transitory computer readable storage medium of claim 22, wherein the first imaging system comprises a monochrome image sensor with infrared illuminators on a left and right side of the monochrome image sensor operating in a first light spectrum range, and wherein the second imaging system comprises a time of flight vertical-cavity surface emitting laser depth imaging system operating in a second light spectrum range, wherein the first light spectrum range is an infrared light spectrum range and the second light spectrum range is a near infrared light spectrum range different from the first light spectrum range.

24. The non-transitory computer readable storage medium of claim 23, wherein the first imaging system is disposed below a display rendering a graphical user interface to the occupant, and wherein the second imaging system is disposed within a vehicle console or rear view mirror located above the occupant within the vehicle, and imaging sensors of the second imaging system are directed down at the occupant with a pitch towards the display.
